(19) United States
(12) Patent Application Publication
(10) Pub. No.: US 2013/0179249 A1
(43) Pub. Date: Jul. 11, 2013

(54) SYSTEM FOR SELECTIVELY GENERATING AND REDEEMING ELECTRONIC COUPONS

(71) Applicant: Frank Easterly, Midlothian, VA (US)

(72) Inventor: Frank Easterly, Midlothian, VA (US)

(21) Appl. No.: 13/737,391

(22) Filed: Jan. 9, 2013

Related U.S. Application Data
(60) Provisional application No. 61/584,504, filed on Jan. 9, 2012.

(51) Int. Cl. G06Q 30/02

(52) U.S. Cl. CPC G06Q 30/0234
USPC 705/14.34

(57) ABSTRACT

A system for generating a personalized digital instant rebate coupon (DIRC) for financial transactions with sponsoring merchants comprises a server-based virtual private network and a group of participating merchants whose point-of-sale systems are attached to the virtual private network, and users having mobile devices connected to the virtual private network, whereby a user completing a transaction with a merchant is provided with a DIRC that may be displayed on the user's mobile device, and may be immediately redeemed at a facility of another participating merchant.

### CROSS-REFERENCE TO RELATED APPLICATIONS

This application claims the benefit of U.S. Patent Application No. 61/584,504 filed Jan. 9, 2012, the disclosure of which is hereby incorporated herein by reference in its entirety.

### BACKGROUND

In the retail space, a coupon is a ticket or document that can be exchanged for a financial discount (an allowance or reductions to a basic price of goods or services) or a rebate (an amount paid by way of reduction, return, or refund on what has already been paid or contributed). Coupons are a type of promotion used primarily as incentives to product sales.

Customarily, coupons are issued by manufacturers of consumer packaged goods or by retailers, to be used in retail stores as a part of sales promotion. They are often widely distributed through mail, magazines, newspapers, the Internet, directly from the retailer, and mobile devices such as cell phones. Since only price conscious consumers are likely to spend the time to claim the savings, coupons function as a form of price discrimination, enabling retailers to offer a lower price only to those consumers who would otherwise go elsewhere.

Most coupons are redeemed as discounts to a basic product price. In the physical space, FSI (Free Standing Insert) coupons dominate pre-store distribution while instant on pack coupons dominate in-store distribution. In the virtual space, print-at-home from a website dominates pre-store distribution and scan-to-card dominates the in-store space.

In 2010 336 billion coupons were distributed with a face value of $485 billion and redeemed at a rate of less than 1% while saving its users $3.3 billion or less than 0.75% of the available redemption value over an average expiration period of 10 weeks. The average redemption value of a coupon was $1.46.

The distribution of physical coupons in 2010 was limited to only 293 manufacturers participating in retail promotion events. The distribution of digital coupons was not limited with thousands of manufacturers and retailers participating in retail promotional events.

The incremental spending, brand trial and repeat visit results from redeemed coupons in the digital space are dramatically higher than in the physical space. But digital coupons account for less than 1% of all coupons distributed in the domestic retail markets even though over 88 million US Internet users will redeem a digital coupon in 2011.

For those consumers who shop and save, 86% clip printed coupons, 64% are printing online coupons, 25% are downloading coupons to their loyalty cards but only 4% are redeeming mobile coupons.

Given the cost inefficiency of the distribution of coupons and the low rate of redemption of coupons, well established retailers and consumers are shifting their behavior from off line to online coupons where distribution costs are less, redemption rates are higher and buying behavior improves for the retailers.

Coupons as rebates are less common but the mail-in rebate (MIR) is the most common form of rebate coupon. An MIR entitles the buyer to mail in a coupon, a receipt and barcode in order to receive a check for a particular amount, depending on the particular product, time, and often place of purchase.

Rebate coupons are offered by either the retailer or the manufacturer of the chosen product. Large stores often work in conjunction with manufacturers, usually requiring two or even three separate rebates for each item. Manufacturer rebates are sometimes valid only at a single store. Rebate forms and special receipts are sometimes printed by the cash register at time of purchase on a separate receipt or available online for download.

In some cases, the rebate may be available immediately, in which case it is referred to as an instant rebate. Some rebate programs offer several payout options to consumers, including a paper check, a prepaid card that can be spent immediately without a trip to the bank when purchasing a product or even cash from the cash register.

U.S. Pat. No. 8,027,917 and U.S. application Ser. Nos. 11/464,694, 13/101,317 and 13/195404 disclose and claim methods and systems for facilitating financial and non-financial transactions between customers, retailers and suppliers using proprietary networks connecting merchants, consumers, and banks or other financial institutions. By directly accessing the demand deposit accounts (DDAs) of parties to a transaction, the system enables identification and authentication of the parties, authorization of specified transactions, and immediate settlement of those transactions. Instructions to settle the transactions are given in the form of automated clearing house (ACH) communications transmitted over a proprietary ACH network to the parties' originating depository financial institution (ODFI) and receiving financial depository institution (RDFI) to trigger the exchange of funds. In this system, referred to as an “eCache system,” a barcode system is used in which a primary barcode is used to identify a customer, an extension, or secondary barcode linked to the primary barcode is associated with a merchant, and the primary and extension barcodes are transmitted to a proprietary server, together with information regarding a purchase. The server will process the data, access any internal or external tables or databases to retrieve additional information needed to complete the transaction, and issue payment instructions via the ACH network to complete the transaction.

### SUMMARY OF THE INVENTION

The invention is a system for generating a personalized digital instant rebate coupon (DIRC), preformatted and encrypted for financial transaction clearance and settlement. It is issued by a sponsoring merchant through a preformatted template submitted to a server-based proprietary virtual private network (VPN) by the sponsoring merchant, and is then distributed through the VPN to a registered user's mobile phone display screen. The registered user is connected to the VPN and is also connected to the sponsoring merchant's point-of-sale (POS) system. Such a system or method may be characterized as a closed loop interoperable merchant network.

In some cases, technological advances have made it possible for merchants, typically smaller businesses, to conduct purchase transactions using computerized systems that do not require a POS system. Such transactions may be completed simply by scanning relevant barcode data, or entering it via a keyboard or other input device, and sending it to “the Cloud,” that is, shared computing resources as a service over the internet, for processing and settlement, such activity taking place at various remote sites accessible through the internet. It will be understood by persons of skill in the art that transaction processing at remote sites is fundamentally no different than if such activity were to take place at a merchant's proprietary POS system, and that transactions involving DIRCs, as described herein, may equally be completed over merchants' systems in which processing and settlement are done remotely with the exception of the merchant's requirement to have a scanner or other comparable input device to collect information locally from the customer (user) or regarding products presented for sale. For ease of explanation, the invention will be described with reference to a merchant's POS, which term as used herein will also encompass transactions performed remotely from a merchant's local computer system, such as through a website associated with a sponsoring merchant.

This invention is suitable to be used together with an eCache system to process and settle transactions on-line between consumers and merchants involving DIRCs. It is equally suitable to be used as a stand-alone application that receives DIRC offers from merchants, applies selection criteria to determine a most optimal DIRC to be offered to a user, transmits the DIRC to the user's mobile device, and redeems a DIRC transaction with the sponsoring merchant, frequently as an off-line non-financial transaction.

The DIRC, in whole or in part, may be characterized and displayed as a barcode with one, two or three dimensional capability from any symbology such as, but not limited to, QR code, or may be characterized and expressed as any machine readable data such as, but not limited to, an RFID code with or without near field communications capability. The DIRC may carry a description of an offer within that coupon and a place and time to present the DIRC to a sponsoring merchant's POS.

The DIRC-generating server will identify the completion of a financial transaction by a registered user at an originating merchant's POS or scanner, and will then analyze the registered user's purchasing history by items purchased within the system's merchant network. It may then select and transmit a coupon from the sponsoring merchant to the registered user's mobile device, using predetermined selection criteria to determine an optimal coupon for that registered user. The server may then authenticate and authorize redemption of the DIRC at that sponsoring merchant's POS or scanner, and may thereafter clear and settle that coupon through the system.

In some embodiments, the server can bypass the purchase history of the registered user and transmit a coupon to the user from a specific sponsoring merchant who may be offering a specific item or items as coupons. In other embodiments, the server can bypass the purchase history of the registered user and the inventory of the sponsoring merchant, and transmit a coupon from the sponsoring merchant without specifying any particular item, simply offering a discount off the ticket value of the item or items purchased from the sponsoring merchant.

The preformatted rebate coupon may be transmitted through the VPN to the registered user's mobile device based on the server's recognition that a separate financial transaction has been completed at a merchant POS or scanner connected to the VPN and to that registered user's mobile device.

In an embodiment, the originating merchant and the sponsoring merchant may be unrelated entities, yet be situated within geographical proximity to one another. The server may select the sponsoring merchant's coupon offer or offers from a data base of registered merchants that have elected to participate in the coupon offer, based on the sponsoring merchant having an establishment that is within a specified distance from the originating merchant. The coupon is deemed valid for a specified, predetermined period of time, and the registered user must redeem the coupon within that time or it will expire. The server may use predetermined criteria to determine which sponsoring merchant's coupon will be offered out of the total number of coupon offers available from competing sponsoring merchants within a defined area.

The server has the capability of receiving, storing, sorting and selecting, from a number of sponsoring merchants who participate in the coupon-offering program, a specific coupon for transmission to an identified registered user. Registered merchants of the system may opt into the sponsoring merchant coupon data base and may create their own DIRC offers through a virtual template provided by the server.

In an embodiment, the system may or may not be connected to the sponsoring merchant's inventory control system in order for the sponsoring merchant to recognize the discounted item offered on the sponsoring merchant's coupon.

In other embodiments, the registered user will have the option of switching on and off the coupon offer function as well as accepting or declining to accept the specific merchant sponsored coupon offer transmitted to the user's mobile phone on the completion of a financial transaction at another merchant's POS or scanner connected to the system.

In some embodiments, the preformatted rebate coupon is encoded with proprietary encrypted code that recognizes the sponsoring merchant's POS or scanner location; pre-authorizes the coupon before it is scanned; and then authenticates the coupon to the registered user when it is scanned at the sponsoring merchant's POS or scanner. The server DIRC may also recognize and is capable of completing the financial transaction settlement on a number of different items having different prices that may be selected by the sponsoring merchant as a potential coupon offer. The server may also access the purchase history of the registered user from any merchant in the system's merchant network, and may associate that user history with a variety of items currently being inventoried by the sponsoring merchant and that are available as an item for offer, and that are thereafter transmitted to the registered user where they may be selected as a coupon offer by the registered user.

The preformatted DIRC is encoded with proprietary encrypted code that authenticates the aggregate ticket value of the items presented for scanning and settlement at the sponsoring merchant's POS or scanner and recognizes which items may be processed against the preformatted rebate coupon and which items are authorized to be processed as open ticket items not subject to the coupon offer.

Sponsoring merchants can access mobile applications and websites connected to the VPN through a preformatted template downloaded from the server to the sponsoring merchant. The sponsoring merchant may prepare a coupon by entering the offered item's SKU from its inventory data base, the item description, the coupon offer description, the expiration period expressed in elapsed hours following presentation or activation, and the coupon discount rate, which may be a percentage of the item's cost, onto the template. The template may then be submitted to the server for registration and potential distribution to registered users of the system.

The server may inventory the sponsoring merchant's item template and, will associate a coupon with a registered user following the authorization of a financial transaction at an originating merchant's POS that is in proximity of the sponsoring merchant. For a specified period of time following presentation, the registered user may present the coupon for redemption at the sponsoring merchant's POS.

In one embodiment, the server is capable of sorting possible coupons according to any combination of parameters. One non-limiting exemplary example of parameters includes: The sponsoring merchant's location and distance from an originating merchant; a registered user's purchase history; the relative value of the coupon offer; and the expiration time following presentation of the coupon offer. The server may also give the registered user a choice of which coupons to redeem depending on the proximity of the offers to the location of the originating merchant's POS or scanner.

The preformatted rebate coupon is encoded with proprietary encrypted code that calculates currency values and settlement routing methods for any of a multitude of parties to the coupon's redemption of the item or items subject to the coupon offer thereby avoiding any outside clearinghouse services or outside third party settlement services of the coupon.

In some embodiments, the system settles transactions using DIRCs on-line, through the previously described eCache system. In other embodiments, the system may settle DIRC transactions off-line, simply by redeeming a DIRC from a sponsoring merchant directly with that merchant at the merchant's facility. Some of such off-line transactions need not be settled through the server, but have been pre-authenticated and preauthorized prior to being offered, and can be cleared by the sponsoring merchant as a non-financial transaction. In this embodiment, the DIRC may be offered to the user via e-mail, which may be based upon a sponsoring merchant's e-mail address list, or through posted or published information providing instructions for accessing a website where users may download mobile applications that provide registration forms for users to register to use the system.

### BRIEF DESCRIPTION OF THE DRAWINGS

FIG. 1 is a diagrammatic representation of the connections for originating merchants and sponsoring merchants to use the system.

FIG. 2 shows the methods by which an individual user can register to use the system and thereafter receive DIRC offers.

FIG. 3 provides an overview of the system and it component parts.

FIG. 4 traces the steps of using the invention to receive and redeem DIRCs through different merchant organizations.

### DETAILED DESCRIPTION OF THE PREFERRED EMBODIMENTS

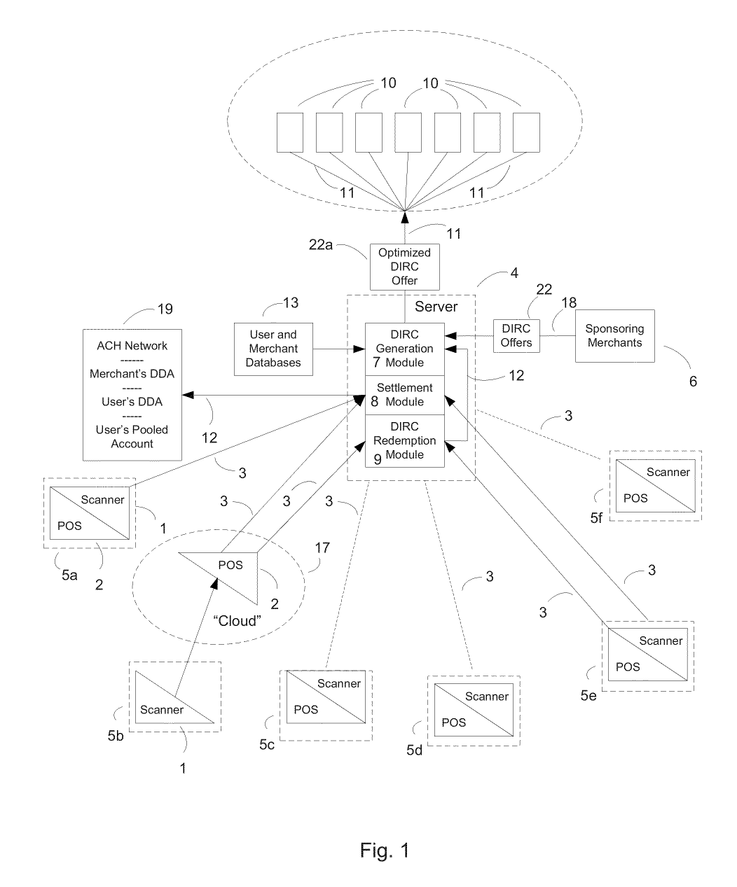

FIG. 1 provides an overview of an embodiment of the system of the invention. Sponsoring merchants 6 provide DIRC offer bids 22 to the server 4 via VPN 18. The server 4 is able to monitor transactions of registered users as those users settle their purchase and DIRC transactions on-line via the server's secure connection to the ACH network 12 and demand deposit accounts (DDAs) of registered merchants and users 19. As described earlier, the method of settling financial transactions may be handled by an eCache system or any other on-line system for the settlement and clearance of transactions. Upon identifying a user, the server 4 will access its database of user and merchant information 13, and based upon a number of user-related parameters, the server will prepare a preformatted optimized DIRC offer 22a specifically created for that user. When the user's immediate transaction with an originating merchant 5a is complete, the server will transmit the preformatted and optimized DIRC offer 22a via wireless VPN 11 in the form of a barcode to the user's mobile device 10. At that point, the user will have the option of accepting the offer and redeeming the DIRC at a sponsoring merchant's location 5b. The sponsoring merchant's DIRC offer 22 that is most suitable for the identified user may be selected on that basis, or it may be selected in accordance with some other predetermined criteria provided to the server 4.

Sponsoring merchants 6 may not have physical facilities where DIRCs may be redeemed, depending upon whether the merchant is a manufacturer, retailer, distributor, website, or occupies another position in the selling of goods or services. In a preferred embodiment, however, sponsoring merchants 6 will normally also be originating merchants 5a-5f, as DIRCs offered by other merchants may be generated (originated) as transactions are completed at an originating merchant's physical facility.

In FIG. 1, a merchant 5a has a barcode scanner 1 associated with a POS 2. The scanner or the POS, or both, are connected to a server 4 via the VPN 3. As previously noted, a merchant 5b may have a POS that includes a scanner, or may have only a scanner that provides scanned data to a remote internet site 5 (“the Cloud”) for processing. Other similarly situated merchants 5c-5f may have scanners and POS systems similarly connected to the server 4 via the VPN 3. Sponsoring merchants 6 are similarly connected to the server 4 via VPN connection 11.

In the embodiment depicted in FIG. 1, the server 4 has at least modules for generating and issuing DIRCs 7, for settling transactions between users and merchants 8, and for redeeming DIRCs 9 in connection with transaction settlements. A VPN connection from server 4 to an ACH network 12 permits the server to issue instructions to debit or credit demand deposit accounts (DDAs) of registered merchants and users. A user's pooled account is also maintained via the ACH network, into which further credits or rebates may be deposited and retained for the user. An internal server communication pathway 12 signals the DIRC generation module 7 to generate a new DIRC upon the redemption of a DIRC in redemption module 9.

Server 4 is also in wireless VPN communication 11 with registered user's mobile devices 10. Any internet accessible device having a display screen, such as, but not limited to an LCD screen, may receive DIRC offers and present them for redemption by a sponsoring merchant. Upon receiving a DIRC via VPN 11, a user has a limited amount of time to travel to the sponsoring merchant's physical facility, where the DIRC may be redeemed. In FIG. 1, a user who has completed a transaction with merchant 5a may receive a DIRC offered by sponsoring merchant 5b via VPN 11, and may redeem the DIRC by making a purchase from merchant 5b. The transaction may be processed via a remote processing facility 17, and the DIRC will be redeemed through server module 9. That module will signal module 7 via internal pathway 12 that a DIRC has been redeemed, and a new DIRC offered by sponsoring merchant 5e will be generated and transmitted to the same user's mobile device 10. The new DIRC may then be redeemed at the facility of merchant 5e. In a preferred embodiment, merchants 5a, 5b and 5e will have physical facilities geographically located within a few minutes travel time from one another.

In generating a DIRC for a registered user, the server 4 may review DIRC offers from sponsoring merchants 6, and may obtain additional information from merchant and user databases 13 to assist in generating a DIRC that is optimized for the specific user. In this regard, the merchant and user databases may provide information such as the user's location (i.e., the redeeming merchant's location) when the last DIRC was redeemed, the relative geographic proximity of sponsoring merchants to the user's immediate location, the user's buying preferences and price ranges, and any other information that may be relevant to the selection of an optimal DIRC for that user.

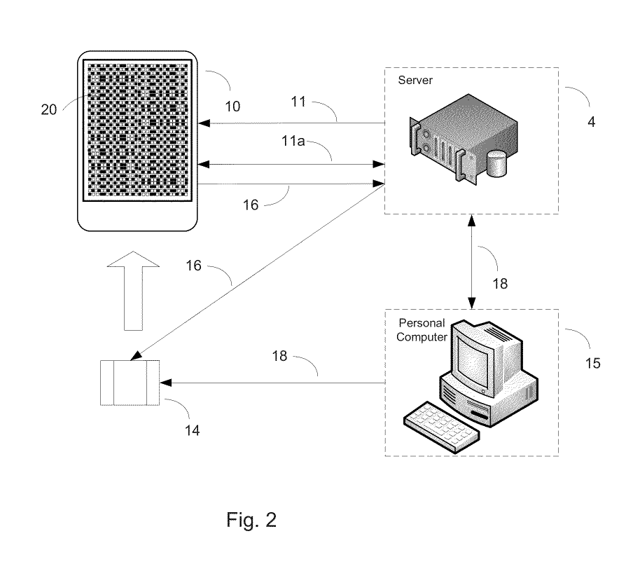

The invention is intended primarily for use on user's mobile devices, although it is not necessarily limited to such embodiments. However, before the invention can be used, a user's mobile device must be registered, and the user must be “paired” with that device. FIG. 2 illustrates two non-limiting methods of registering a mobile internet accessible device by a user. In the first method, a user may use his or her mobile internet accessible device 10 to establish an insecure connection 16 to the server 4 to download a mobile application 14. The mobile application 14 has a registration component that is used to provide registration information to the server 4, and an operational component that will remain inactive until registration has been completed. Communication with the server 4 may initially involve a public, or insecure connection 16, but, once installed, will revert to use of a wireless VPN 11a for transmission of the user's registration information. Thereafter, the mobile device 10 will communicate with the server 4 and will receive DIRC offers via a wireless VPN 11.

A second method of registration will involve the user's accessing the server 4 via an internet connection to a personal computer 15 or other internet accessible device. Once a secure connection 18 has been established, the user can provide registration information, and may download a mobile application for installation upon the user's mobile internet-accessible device 10. Registration and downloading of the mobile application can also be accomplished in any of a number of other well-known methods.

The registration process involves pairing a user to the user's mobile device 10 through a unique coded alphanumeric sequence. In a preferred embodiment, the pairing may be achieved by using the telephone number of the mobile device 10. When access to the server 4 is desired, the user must authenticate himself or herself through the use of a unique PIN, which may be an alphanumeric sequence, and which the server will recognize as appropriate for the registered user using the paired mobile device. Once registration has been accomplished, DIRCs in the form of two or three dimensional barcodes 20, can be offered to the user by being pushed to the mobile device 10 via a wireless VPN 11.

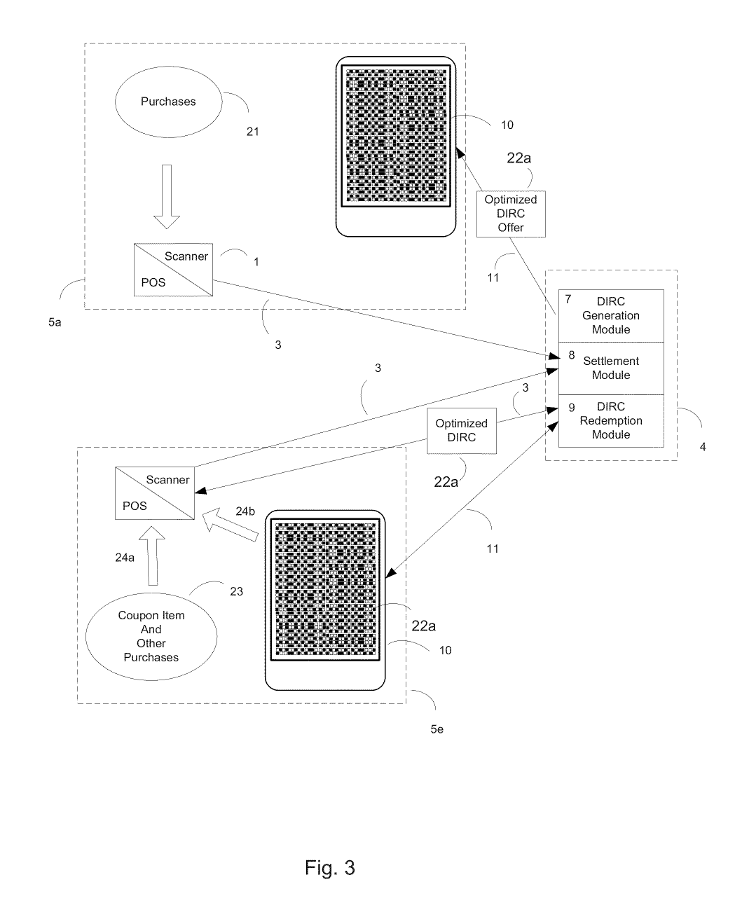

FIG. 3 demonstrates an embodiment in which a user is presented with a DIRC offer, accepts the offer and redeems the DIRC, and receives another DIRC in the process. At merchant 5a, a user completes a purchase on-line when information regarding the purchase 21 is presented to the scanner 1 of originating merchant 5a, is transmitted through a VPN connection 3 to a settlement module 8 of a server 4. The server 4 recognizes the completion of the transaction and further recognizes that the user has a mobile device 10 that is registered to receive DIRC offers. The server 4 then generates an optimized DIRC offer 22a from a sponsoring merchant 5e and transmits the offer to the user's mobile device 10 via wireless VPN 11. The DIRC offer is represented by a barcode that may be viewed as a barcode on a display screen of the device 10.

The DIRC offer 22a is redeemable at the sponsoring merchant's nearby facility. If the user accepts the DIRC, he or she may go to the sponsoring merchant's facility 5e and select an item that may be used with the DIRC along with any other purchases 23 to be made from that merchant. The user is then authenticated to the server 4 via VPN connection 11, and the merchant's POS receives an authorization over VPN 3 to accept the DIRC. The user then recalls the barcode representing the DIRC 22a to the display screen of the mobile device 10.

Upon the user's presenting the items to be purchased 23 and the DIRC 22a to the sponsoring merchant 5e, the purchased items will be scanned 24a and the barcode representing the DIRC 22a will be scanned 24b. Data representing the DIRC 22a will be transmitted to the DIRC redemption module 9 of the server 4 via VPN connection 3, and data representing the other purchases in the transaction will be sent to the settlement module 8 of the server 4. The server's redemption settlement module 9 will complete the DIRC settlement and discount proceeds may be distributed in accordance with predetermined criteria. In embodiments where the DIRC system of this invention is used in conjunction with another on-line settlement system, such as but not limited to the eCache system described earlier, all financial transfers may also be settled and cleared. The server 4 may then repeat the sequence by offering a similar DIRC 22a from another sponsoring merchant to the same registered user, thereby perpetuating the DIRC offers to the registered user. In a preferred embodiment, the DIRC will have a limited lifetime within which it may be redeemed, after which it will no longer be effective.

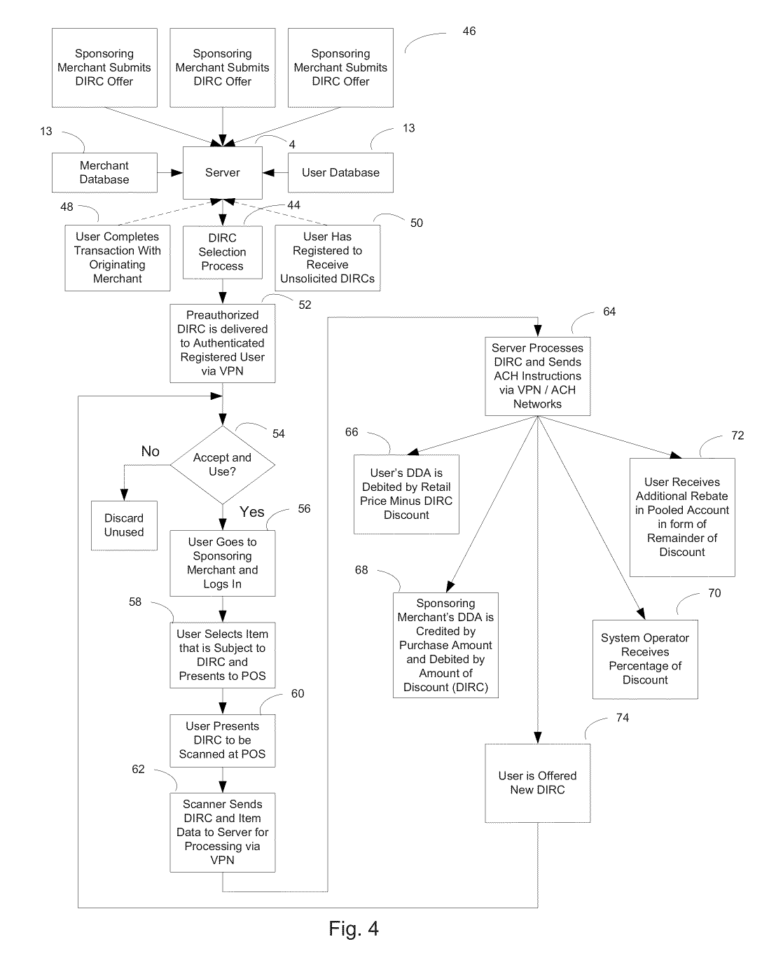

FIG. 4 depicts flow chart representing the steps in an embodiment of the invention. Sponsoring merchants 46 offer digital-instant-rebate-coupons (DIRCs) as bids to the proprietary server 4 of the invention. Bids are received and the server conducts a DIRC selection process 44, using historical complied data from user and merchant databases 13, and instantaneous data indicating a location where a registered user has just completed a purchase transaction 48. Using an algorithm to assess available information to select a sponsoring merchant's DIRC that is most suitable for the user, the server selects a DIRC, authorizes its use by an authenticated user 50, and transmits the DIRC offer to the user 52.

If the user accepts the DIRC 54, he or she will go to a nearby physical facility 56 offering the sponsoring merchant's item for which the DIRC was issued, will select one or more items for purchase 58, and will present them to the merchant's POS for processing 60. The user will contemporaneously log in 56 and identify himself or herself using a PIN to authenticate himself or herself to the server.

A scanner at the merchant's POS will scan items to be purchased 62, and will scan the DISC, which is now represented as a two- or three-dimensional barcode on the display screen of the user's mobile internet-accessible device. Upon completion of the scanning, data will be sent to the server via a VPN for processing 64. In an embodiment depicted in FIG. 4, the user's DDA will be debited by the retail price of purchased goods minus the monetary value of the DIRC 66. The sponsoring merchant's DDA will be credited by the amount of the purchase minus the monetary value of the DIRC 68. The system operator of the invention will receive a credit or payment based upon predetermined criteria that may be based on a percentage of the monetary value of the DIRC, or that may be a flat amount 70. A user's pool, representing additional credits available to the user, will be credited by the difference between the monetary value of the DIRC and the amount taken by the system operator 72. In this manner, the user receives not only the face value of the DIRC, but also receives an additional credit, or rebate, that is added to a pooled account and made available to the user for credit in other purchases or redemption at cash value. In addition, the user is presented with another DIRC offer 74, which may be accepted by using it in the manner just described, or may be ignored, in which case it will go unused. The sequence of issuing a DIRC at the completion of a prior transaction perpetuates the availability of coupon offers to a registered user as long as the user redeems each DIRC offered.

In some embodiments, the server creates a pool of registered users and merchants through an initial registration process using mobile applications. Merchants can register through a unique mobile application which, after registration, will leave a resident client program to process transactions at the merchant's point of sale through a VPN. The server recognizes the merchant's POS through a pairing function of merchant to the mobile device the merchant uses as his POS during the initial registration process. In addition to being sent via a VPN, the DIRC may also be encrypted and in the form of a template. The server will recognize the sponsoring merchant's pre-authorization of the DIRC and the DIRC's encrypted template at the registered merchant's POS when the DIRC is scanned and transmitted.

Settlement of the transaction involving the DIRC can be done in a number of ways. In an embodiment particularly suited to retailers who offer the DIRC, the merchant-retailer offers the item at a discounted price, and will bear the lost value incurred in the sale of the item at the discounted price. The difference between the selling price and the discounted price will be divided between the customer/user and the system operator. The user will receive the item at the discounted price, which is paid by the user and immediately credited to the merchant-retailer. In addition, however, a portion of the difference between the listed selling price and the discounted price will be placed in the user's pooled account, while the remainder of that difference will immediately be credited to the system operator. This settlement scheme may be demonstrated in the following examples, in which:

SP=listed selling price of the item targeted for a DIRC from the merchant's inventory.

SPc=DIRC published selling price of the target item in a currency format

CD=DIRC discount in a currency format

CDr=coupon discount rate as a percentage

RD=rebate discount rate as a percentage

CR=DIRC rebate in a currency format

MSA=merchant settlement amount in a currency format

### Example 1

A sponsoring merchant offers an item at listed selling price of $25 (SP=$25). A customer/user has received DIRC which, when presented, allows user to purchase item for $15 (SPc=$15). The coupon (DIRC) discount is $10 (CD=$10). If the transaction is made only for the purchase of the item, the merchant will receive $15 (MSA=$15). If the transaction is completed on-line using an eCache-type of settlement, the MSA will immediately be credited to the merchant's DDA; the SPc will immediately be debited from the user's DDA; and the CD will be distributed to the system operator. Depending upon the system operator's prior arrangements with the user, a portion of the CD will immediately be rebated (credited) to a pooled “stored value” account, which may be a DDA that is controlled by the user, or may be a trust account maintained by the system operator for the benefit of the user. The amount credited to the user's pooled account may be determined as a flat currency amount (CR), or may be a percentage of the transaction value (RD). If the RD is 40%, then the user's pooled account will be credited by $4 and the system operator will retain the remainder ($6). Alternatively, if the CR is a flat amount (for example, $5), then the user's pooled account will be credited by that amount ($5) and the system operator will retain the remainder ($5).

### Example 2

A sponsoring merchant offers an item at a listed selling price of $40 (SP=$40). A customer/user has received a DIRC which, when presented, allows the user to purchase the item at a 20% discount (CDr=20%). The coupon (DIRC) discount is $8 (CD=20%×$40=$8). Upon settlement, the merchant will receive $32 (MSA=$32), which will be credited to the merchant's DDA; the user's DDA will be debited by $32 (SPc=$40−(20%*40)); and the system operator will receive $8 to be distributed between itself and the user's pooled account in accordance with predetermined criteria.

### Example 3

A sponsoring merchant offers an item at listed selling price of $20 (SP=$20). A customer/user has received DIRC which, when presented, allows user to purchase item for $15 (SPc=$15). The coupon (DIRC) discount is $5 (CD=$5). The user goes to the sponsoring merchant's facility and selects a number of non-discounted items for purchase totaling $45, also selects the item that is subject to the DIRC discount. In this case, all items except the one subject to the DIRC will be purchased at the merchant's listed selling price, and the merchant's settlement amount (MSA) will be $45 plus the price of the discounted item $15, for a total of $60, which will be credited to the merchant's DDA. The same amount, representing the listed sales price of the other items and the discounted price of the discounted item, will be debited from the user's DDA. The discount amount ($5) will go to the system operator where it will be divided between the system operator and the user's pooled account as previously agreed between the system operator and the user.

In an embodiment, the barcode associated with the sponsoring merchant's coupon offer may be encoded with encrypted protocol unique to that registered merchant's specific coupon offer through a preformatted template available to that sponsoring merchant that uses the data entries and calculations listed in connection with the examples. The protocol presented in the form of a barcode forms the basis for the authentication and authorization of the settlement of the sponsoring merchant's coupon through a pre-authorized ACH for the calculated amount of the CR and the calculated amount of the MSA by the formulae expressed in a currency format below:

SPc=SP(1−CDr); where

CD=SP−SPc; where

CR=RD(SP−SPc); and

MSA=SPc−CR

In such an embodiment, the registered sponsoring merchant's issuance of a DIRC to the registered user (via the server) constitutes a pre-authorization to settle the financial transaction of that coupon item's value (SPc) through two ACH transactions by routing the value of the credit rebate (CR) to the server and then to an ODFI through a pre-authorized ACH for deposit, and by routing the merchant settlement amount (MSA) to the merchant's acquiring account through a pre-authorized ACH to the register user's DDA for withdrawal in favor of the merchant's acquiring account.

In addition the server directs a percentage of that coupon rebate (CR) to a pooled account at an ODFI where it remains available as {{stored value” for credit for future financial transactions through an ACH for goods and services initiated by registered users to registered merchants of the VPN. The VPN directs the net balance of the rebate to the VPN's operating account where it is recognized for accounting purposes as cash on hand and revenues.

The server maintains a daily record of the currency balance of the aggregate DIRC rebates for each registered user and makes that amount available to the user through the user's pooled account for funding the partial or complete settlement of financial transactions for goods and services at any registered merchant of the system. This may be done using a barcode initiated by the registered user's application, which is generated by the server and presented as a barcode on the users mobile device connected. In this embodiment, the user simply selects the cash option and loads the amount of stored value, up to the balance in the pooled account to be credited against the transaction. The stored value balance is presented in real time to the registered user through the wireless VPN connected to the user's mobile device.

The amount to be credited to the merchant transaction will be withdrawn from the user's stored value account and set up as an ACH through the ODFI, and aggregated to the MSA of that transaction.

In another embodiment, the invention may be practiced by on-line merchants, including manufacturers, distributors, and retailers. In this embodiment, a DIRC may be delivered to an on-line user upon completion of an on-line transaction, or upon the occurrence of some other activity. Upon receiving a DIRC offer, the user may access a site offering the item that is the subject of the coupon; and, upon completing the on-line purchase, may provide the DIRC to receive the discount. In this scenario, the DIRC may constitute a digital file that represents a barcode which may or may not be encrypted; or the DIRC may comprise an alphanumeric sequence that is representative of a barcode, or may take some other form known to persons of skill in the art. In any case, the DIRC may be presented on-line at the time of settlement, and the settlement processes described earlier may be employed to settle and clear the transaction.

Persons of ordinary skill in the art will readily appreciate that other settlement schemes may be used, including transactions in which the sponsoring merchant may be a manufacturer or distributor, rather than a retailer. Such transactions may be immediately settled as explained above, with the party offering the discounted item receiving only the amount that it would have received less the amount of the discount.

I claim:

1. A system for generating a personalized digital instant rebate coupon (DIRC) for financial transactions with sponsoring merchants, said system comprising:
a server-based proprietary virtual private network (VPN);
a DIRC comprising at least a barcode that may be displayed on a mobile device, said DIRC being stored and maintained on said VPN server and being authorized by a sponsoring merchant;
one or more merchants connected to said VPN, said one or more merchants having point-of-sale (POS) system or a remote POS system capability, said one or more merchants including at least said sponsoring merchant;
one or more users having mobile devices in communication with said VPN;
said system further comprising the steps of said sponsoring merchant authorizing said DIRC to be provided to one of said one or more users by said server sending said DIRC to said user's mobile device upon said user's engaging in a financial transaction with one of said one or more merchants; and
said user redeeming said DIRC by initiating a transaction with said sponsoring merchant and presenting said barcode on said user's mobile device to said sponsoring merchant and said sponsoring merchant accepting said DIRC and completing said transaction with said user.
